(19) United States
(12) Patent Application Publication
(10) Pub. No.: US 2011/0210470 A1
(43) Pub. Date: Sep. 1, 2011

(54) CRUCIBLE AND METHOD FOR FURNACE CAPACITY UTILIZATION

(75) Inventors: Scott Nichol, Toronto (CA); Dan Smith, Brampton (CA); Damon Dastgiri, Scarborough (CA); Fritz Kirscht, Berlin (DE)

(73) Assignee: 6N Silicon Inc., Vaughan (CA)

(21) Appl. No.: 12/716,889

(22) Filed: Mar. 3, 2010

Related U.S. Application Data
(60) Provisional application No. 61/308,817, filed on Feb. 26, 2010.

(51) Int. Cl. B22D 7/06; B29C 39/02; B22D 7/08

(52) U.S. Cl. 264/160; 264/299; 249/174; 249/160

(57) ABSTRACT

The present invention relates to efficient furnace capacity utilization in the production of ingots. The present invention includes a crucible and use of the same. The crucible approximately matches the interior shape of the furnace in which the ingots are produced.

### CROSS REFERENCE TO RELATED APPLICATION(S)

This application claims the benefit of U.S. Provisional Application No. 61/308,817, filed Feb. 26, 2010, the disclosure of which is incorporated herein by reference in its entirety.

### BACKGROUND

The solidification or crystallization of some materials from their liquid states can sometimes produce a solid with more consistent structural qualities when performed in the absence of certain gasses or other foreign materials that can contaminate or react with the material. For example, the material in contact with or nearest a crucible can be contaminated from the crucible or from the coatings of the crucible as it solidifies; this impure material may be trimmed off the solid material after solidification is complete. By solidifying the materials into larger shapes, the surface area of the material that is exposed to air or the crucible or other contaminants during the process can be minimized, therefore material wasted by trimming off material made impure by contamination can be minimized. In another example, the last-to-freeze material often has the highest contaminant concentration can be located at the surfaces of a solidified material, and often these surfaces are also trimmed off a solidified material before use. By having a smaller ratio of surface area to volume, this wasted material is minimized by using larger shapes. Advantages of larger scale have encouraged the use of larger furnaces and larger crucibles for formation of ingots from molten materials, especially where the intended use for the resulting ingots requires high-quality ingots.

For example, since the process for manufacturing multicrystalline ingots for producing solar cells was invented, there has been a trend towards larger and larger furnaces, crucibles, and ingots. As furnaces have gotten larger, larger crucibles and ingots have been produced. The economies of scale with a larger ingot reduce costs. Larger ingots have less surface area for contamination and produce better quality blocks with less contamination from the crucible and the furnace atmosphere, and less waste of silicon.

A current standard is 6″×6″ (156 mm×156 mm) blocks or wafers, which are cut from an ingot after casting. In a 240 kg furnace, 16 blocks are made in a 4×4 grid (see Table 1). The corner blocks and side blocks tend to result in lower quality solar cells. The 4×4 grid produces 4 corner blocks, 8 side blocks, and 4 center blocks. With a 450 kg furnace a 5×5 grid is used and 25 blocks are produced (see Table 1). This produces 4 corner blocks, 12 side blocks, and 9 center blocks. Thus, a larger crucible produces more center blocks and less corner and side blocks of a given size as a ratio of the number of blocks per crucible, see for example Table 1.

TABLE 1

| | 156 mm × 156 mm Blocks per Crucible | | |
|---|---|---|---|
| | 16 blocks, | 25 blocks, | 36 blocks, |
| | 240 kg ingot | 450 kg ingot | 750 kg ingot |
| side | 50% | 48% | 44% |
| corner | 25% | 16% | 11% |
| center | 25% | 36% | 44% |

The transition from a 240 kg crucible to a 450 kg “jumbo” crucible did not result in a larger furnace being built by most furnace manufacturers. Generally, the inside of the furnace and the software used to control the furnace was slightly modified to accommodate the larger crucible, which went from approximately 72 cm×72 cm×42 cm to 88×88×42 cm in size. Moving up to the next size of crucible will result in a crucible size of approximately 103 cm×103 cm×42 cm, which would be very difficult to fit into the furnace due to the larger size of the crucible and the square shape of the crucible. As the height of a crucible increases, the height to width ratio of the crucible can be maintained by also increasing the length and width, but not by just increasing the height alone. Making a taller crucible without increasing the length and width to increase weight of silicon per batch can make a lower quality ingot since it gets harder and harder as the height grows to maintain the temperature gradient from the bottom to the top of the ingot.

### BRIEF DESCRIPTION OF THE DRAWINGS

In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

FIG. 1 shows a top-view of a 32 block 156 mm×156 mm crucible according to an embodiment of the present invention.

FIG. 2 shows top-view of a 32 block 156 mm×156 mm ingot in a crucible according to a specific embodiment of the present invention.

FIG. 3 shows a side-view of the crucible 100 according to a specific embodiment of the present invention.

### SUMMARY

The present invention provides a crucible and method of using the same for efficient furnace capacity utilization in the production of an ingot. The crucible includes an interior for the production of an ingot. The crucible also includes an exterior shape that approximately matches the interior shape of the furnace in which the ingot is produced.

Embodiments of the invention can provide an ingot that gives a batch of blocks of overall higher quality. The crucible and method can also produce more blocks in a single batch of blocks in a given furnace than similar crucibles and methods. The ingot can be a silicon ingot, and if used to make solar cells, the blocks derived from the ingot can produce more efficient solar cells.

The present invention provides a crucible that includes an interior for the production of an ingot. The crucible includes an exterior shape approximately matching the interior shape of a furnace in which the ingot is produced. The ingot also includes a multiplicity of blocks. Additionally, the multiplicity of blocks are arranged in a grid. The exterior shape of the crucible matching the interior shape of the furnace can allow for the generation of a larger number of blocks than the number of blocks that could be generated from the furnace using a crucible with a square shape. Also, the interior shape of the furnace has an approximately round shape. The crucible also has an exterior perimeter that includes approximately eight sides. Additionally, the eight sides of the crucible include two sets of approximately opposing longer sides of approximately equal length. In addition, the eight sides of the crucible can also include two sets of approximately opposing shorter sides of approximately equal length. Additionally the eight sides of the crucible are such that the longer sides of the crucible alternate with the shorter sides of the crucible.

The method of the present invention provides the use of a crucible with an interior for production of an ingot. The method also provides the use of a crucible with an exterior shape that approximately matches the interior shape of the furnace in which the ingot is produced. In a specific embodiment, the ingot produced by the method is a silicon ingot.

### DETAILED DESCRIPTION

Reference will now be made in detail to certain claims of the disclosed subject matter, examples of which are illustrated in the accompanying drawings. While the disclosed subject matter will be described in conjunction with the enumerated claims, it will be understood that they are not intended to limit the disclosed subject matter to those claims. On the contrary, the disclosed subject matter is intended to cover all alternatives, modifications, and equivalents, which can be included within the scope of the presently disclosed subject matter as defined by the claims.

References in the specification to “one embodiment”, “an embodiment”, “an example embodiment”, etc., indicate that the embodiment described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

In this document, the terms “a” or “an” are used to include one or more than one and the term “or” is used to refer to a nonexclusive “or” unless otherwise indicated. In addition, it is to be understood that the phraseology or terminology employed herein, and not otherwise defined, is for the purpose of description only and not of limitation. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

In the methods of manufacturing described herein, the steps can be carried out in any order without departing from the principles of the invention, except when a temporal or operational sequence is explicitly recited. Recitation in a claim to the effect that first a step is performed, then several other steps are subsequently performed, shall be taken to mean that the first step is performed before any of the other steps, but the other steps can be performed in any suitable sequence, unless a sequence is further recited within the other steps. For example, claim elements that recite “Step A, Step B, Step C, Step D, and Step E” shall be construed to mean step A is carried out first, step E is carried out last, and steps B, C, and D can be carried out in any sequence between steps A and E, and that the sequence still falls within the literal scope of the claimed process. A given step or sub-set of steps can also be repeated.

Furthermore, specified steps can be carried out concurrently unless explicit claim language recites that they be carried out separately. For example, a claimed step of doing X and a claimed step of doing Y can be conducted simultaneously within a single operation, and the resulting process will fall within the literal scope of the claimed process.

Embodiments of the invention relate to a crucible and method for efficient furnace capacity utilization in the production of an ingot. The crucible can include an interior for the production of an ingot. The crucible can include an exterior shape that approximately matches the interior shape of the furnace in which the ingot is produced. The method provides the use of the crucible for the production of an ingot. The method also provides the use of a crucible with an exterior shape that approximately matches the interior shape of a furnace in which an ingot is produced. In a specific embodiment, the method provides the production of blocks from the ingot using a cutting device. The ingot can be cut into blocks using a wire saw, band saw, circular saw or other cutting methods. The ingot can be silicon.

The apparatus and method of the present invention can make more efficient use of furnace capacity than other apparatus and methods. By efficiently utilizing available furnace space, the crucible and method of the present invention can produce more blocks in a single batch of blocks. By making better use of available furnace space, the purchasing of a larger furnace can be avoided. Crucibles and methods according to the present invention can also produce a batch of blocks with a smaller proportion of corner blocks. Since corner blocks, cut from the corner of an ingot, can be of lower quality, the invention can provide a batch of ingots of overall higher quality. Crucibles and methods according to the present invention can achieve improved throughput of high-quality material. When the apparatus and method is used to generate silicon ingots for solar cells, the solar cells can overall have improved cell efficiency.

### DEFINITIONS

As used herein, “block” refers to a piece of an ingot that can be any shape. Generally, a block is square shaped.

As used herein, “side block” refers to a block that shares one side with the perimeter of an ingot.

As used herein, “center block” refers to a block that does not share a side with the perimeter of an ingot.

As used herein, “corner block” refers to a block that shares two sides with the perimeter of an ingot.

As used herein, “coating” refers to a layer of material that covers at least part of another material, wherein the layer can be as thick, thicker, or thinner than the material that it covers.

As used herein, “counter-sunk” refers to a manner of installing a screw, bolt, or similar hardware wherein a secondary conical or semi-conical hole of wider circumference is made closer to the surface of a material approximately above a primary cylindrical hole of a particular circumference in that material, such that the hardware does not protrude above the surface in which it is installed, or such that the hardware protrudes less above the surface in which it is installed than if there was not a secondary hole.

As used herein, “counter-bored” refers to a manner of installing a screw, bolt, or similar hardware wherein a secondary cylindrical hole of wider circumference is made closer to the surface of a material approximately above a primary cylindrical hole of a particular circumference in that material, such that the hardware does not protrude above the surface in which it is installed, or such that the hardware protrudes less above the surface in which it is installed than if there was not a secondary hole.

As used herein, “crucible” refers to a container that can hold molten material, that can hold material as it is melted to become molten, and that can hold molten material as it solidifies or crystallizes or a combination thereof.

As used herein, “curve” refers to a surface that is approximately curved, or following an approximate arc shape, and need not be completely curved. In approximating whether a surface is curved, the average is considered, such that a surface that in some parts (including one part), several parts, or in all parts follows a straight line or lines can be a curved surface if overall the surface follows an approximate arc.

As used herein, “grid” refers to at least two blocks, the pattern of the edges of the blocks forming generally a pattern of regularly spaced horizontal and vertical lines.

As used herein, “ingot” refers to a block of solid or crystalline material or materials, or a combination thereof.

As used herein, “internal angle” refers to the angle formed between two surfaces that is the smaller angle of the two angles.

As used herein, “flat side” refers to a side that is approximately straight, is minimally curved overall, and need not be completely flat. In approximating straightness, the average is considered, such that a side that curves slightly back and forth several times can be a flat side if overall the side follows an approximately straight line.

As used herein, “furnace” refers to a machine, device, apparatus, or other structure that has a compartment for heating a material.

As used herein, “furnace capacity” refers to the volume of a compartment of a furnace.

As used herein, “octagonal” refers to a shape or object having eight sides.

As used herein, “perimeter” refers to the outer edge of an object or shape.

As used herein, “round” refers to a shape that does not have sharp corners, for example a shape that does not have 90 degree corners. A round shape can be circular or oblong. A round shape can include a square shape with the edges rounded-off.

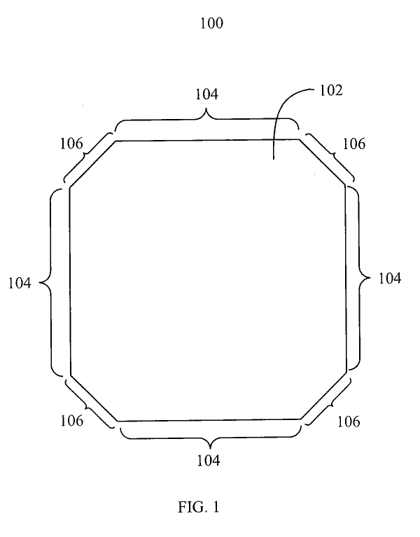

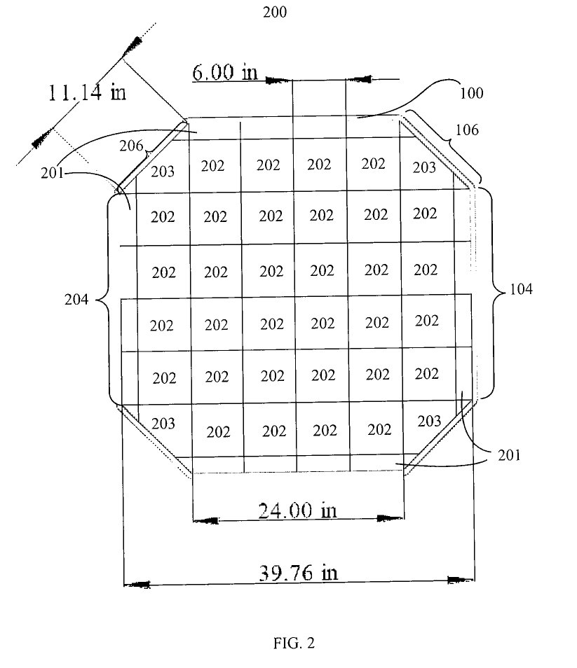

Referring to FIG. 1, a top-view of crucible 100 is shown, according to some embodiments. The crucible 100 includes an interior 102 for the production of an ingot. Referring to FIG. 2, a top-view of an ingot 200 in crucible 100 is shown. The ingot 200 can include portions of the perimeter 201 that are trimmed off after the molten material goes through solidification, crystallization, or a combination thereof. The ingot 200 includes a multiplicity of blocks 202. The blocks 202 can be formed from ingot 200 using a cutting device. The ingot can include silicon. The molten material can include molten silicon. The blocks 202 are arranged within the ingot 200 in a grid. The exterior shape of crucible 100 approximately matches the interior shape of a furnace in which ingots are produced, which can be a furnace with an interior compartment with an approximately round shape. By approximately matching the interior shape of the furnace, crucible 100 can fit a larger quantity of molten material in the furnace, thus can more efficiently utilize the capacity of the furnace. By approximately matching the interior shape of an approximately round furnace, the crucible 100 can generate an ingot 200 that give a larger number of blocks 202 than the number of blocks that can be generated from the furnace using a crucible with a square shape. When compared to a grid in an ingot from a square-shaped crucible, in ingot 200 the percentage of side or center blocks relative to the percentage of corner blocks can be greater, and the percentage of side blocks relative the to percentage of center blocks can be increased. See table 2. When compared to a square-shaped crucible, the percentage of corner blocks in ingot 200 from crucible 100 has been reduced.

TABLE 2

| | Blocks per Ingot | | | |
|---|---|---|---|---|
| | 16 blocks, | 25 blocks, | 32 blocks, | 36 blocks, |
| | square crucible | square crucible | crucible 100 | square crucible |
| side | 50% | 48% | 50% | 44% |
| corner | 25% | 16% | 0% | 11% |
| center | 25% | 36% | 50% | 44% |

The crucible of the present invention includes blocks. The blocks are joined together in the ingot that results from the crucible; therefore, the ingot includes blocks. They become separate blocks by being cut apart from one another after the casting process is complete. The blocks can be cut in a grid pattern. The cutting can be done by any suitable cutting device known to those in the art. An example of a suitable cutting device is a saw that uses abrasive material, such as diamond, or cutting teeth, attached to a band that turns in a continuous loop. The cutting may include cooling with water to prevent overheating of the blade. Another example of a suitable cutting device is a wire saw which uses steel wire with cooling fluid and SiC grit or steel wire coated with diamond grit and a cooling fluid.

The causes of the inferior quality of an ingot can include the proximity of the solidified or crystallized material to the walls of the crucible. The crucible can be coated with or include a material that prevents the material from sticking to the crucible, allowing for easy removal of the solid. While helpful to prevent sticking, the coating or constituent of the crucible can diffuse into the molten material, affecting the purity of the solid material closest to the walls of the crucible. Therefore, when less of an ingot contacts the walls of the crucible, less material is contaminated by diffusion from a constituent or coating of the crucible. Additionally, the top surface of the silicon in the crucible in the corners can solidify last, and last-to-freeze material in a crystallization can contain the highest levels of impurities. The last-to-freeze portions of an ingot can be removed prior to use, e.g. with a cutting device, prior to use of the ingot. When less of an ingot contacts the walls of the crucible, less material is wasted by needing to trim it from the ingot prior to use. The present invention includes ingots that have less corners, such that they include less blocks that share two edges with the perimeter of the crucible. The present invention can thus produce a smaller percentage of lower quality product and can result in less waste or in less recycled silicon.

Again referring to FIG. 1, the crucible 100 includes a perimeter which includes eight sides, 104 and 106. The eight sides include two sets of approximately opposing first sides 104 which are of approximately equal length. The eight sides also include two sets of approximately opposing second sides 106 which are of approximately equal length. The eight sides of crucible 100 correspond to eight sides of the ingot 200 that is formed from the crucible 100, including first sides 204 and second sides 206. The first sides 104 and the second sides 106 are approximately flat. The first sides 104 are longer than the second sides 106. The first sides 104 alternate with the second sides 106. In a specific embodiment, the height of crucible 100 can be 2-20 cm taller than other crucibles, which can allow, for example, the same amount of silicon as a 36-block 750 kg square crucible could hold. Generally, in the present invention the height of the crucible can be made taller so that, e.g., lower density material such as lower density silicon can be used economically, such that that more material can be loaded into the crucible.

In a specific embodiment, the first sides 204 can be approximately 24.00 inches. The second sides 206 can be approximately 11.14 inches. The dimensions of the blocks 202 can be 6.00 inches×6.00 inches. The thickness of the sides of the crucible can be 0.67 inches. The thickness of the material removed from the sides of the ingot 200 can be 1.88 inches.

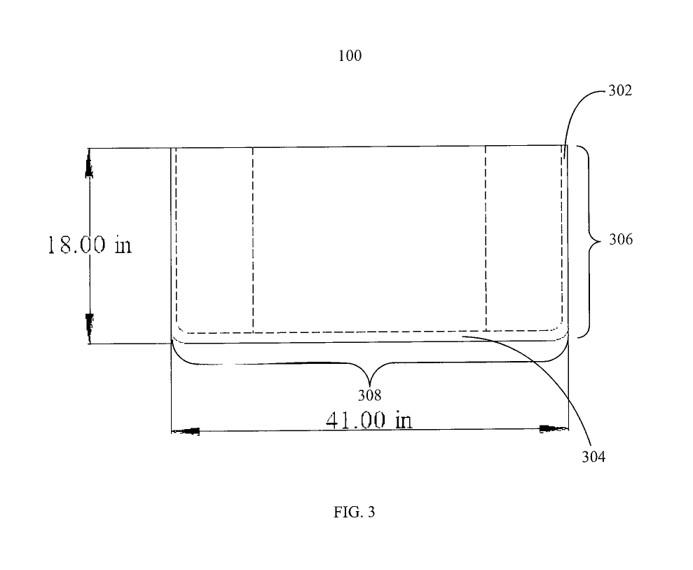

Referring to FIG. 3, a side view of the crucible 100 in a specific embodiment is shown. The width of the crucible 308 can be 41.00 inches. The height of the crucible 306 can be 18.00 inches. The sides 302 can be 0.67 inches thick. The crucible can have a bottom 304.

The crucible can include first sides and second sides that are approximately the same length. The crucible can include first sides that are curved, or that include curves, and the crucible can independently include second sides that are curved, or that include curves. Therefore, the crucible can include first sides that are curved, and second sides that are approximately straight; the crucible can also include second sides that are curved, and first sides that are approximately straight. The curve of a side can include multiple approximately flat surfaces that taken together form an arc shape, or that form more than one arc. The curve of a side can include one single curve. The curve of a side can include multiple curved surfaces that taken together form an arc shape, or that form more than one arc.

The design can include a furnace that has four crucibles in it and only one corner in each crucible is reduced in area.

The crucible of the present invention can be made from or include silica, SiC, quartz, graphite, Si₃N₄, or a combination thereof. The choice of constituents or coatings can include, for example, non-sticking properties, as well as heating resistant properties. The crucible can include a coating that contains Si₃N₄, graphite, or SiO₂ which can coat the crucible partially, completely, or to any degree in-between. The crucible can include internal angles between sides included in the perimeter of approximately 110-160 degrees. The crucible can include internal angles between sides included in the perimeter of approximately 125-145 degrees. The crucible can also include outer or inner corners and edges that are curved.

The present invention provides a method of using a crucible with an interior shape for the production of ingots, including the crucible as described above, wherein the exterior shape of the crucible approximately matches the interior shape of a furnace in which ingots are produced. The interior shape of the furnace can be approximately round. The interior shape of the furnace can be modified to fit the crucible.

In one specific embodiment, the dimensions of the crucible are such that the method can generate 32 156 mm×156 mm blocks from a 25 block 156 mm×156 mm 450 kg furnace. In another embodiment, the dimensions are such that that the method can generate 21 180 mm×180 mm blocks from a 25 block 450 kg ingot furnace.

The present invention can provide a method for improving the throughput of high-quality material. The present invention can provide a method for efficient and cost-effective quality control of the resulting ingots. Referring to the specific embodiment depicted in FIG. 2, the extra 4 half-blocks 203 can be used for destructive and nondestructive testing to improve quality and speed up throughput time of wafer manufacturing. Measuring only 4 corner blocks 203, rather than all the blocks 202, can save time and related costs, including: saving measurement time, saving time needed for block cleaning after conducting measurements, and saving time needed for block cleaning before conducting block cutting post measurements. This can help to achieve higher throughput while maintaining necessary material quality.

The following measurements are included among those that can be conducted to help to control the quality of the material generated: a) measurement of axial (bottom-to-top) resistivity profiles on blocks, complemented by b) mapping recombination lifetime (bottom-to-top) and, in cases of high-carbon feedstock or at poor carbon control of the casting tool, the additional step c) infrared (IR) scanning for silicon carbide particles (bottom-to-top). Having the 4 corner blocks on which to conduct these measurements can have a beneficial outcome. Measurement a) can give reliable information about the growth front of the total ingot if specific growth characteristics of individual casting tools are known (this can be determined for every casting tool). Subsequent wafering can be based on information about the growth front. Measurement b) can allow measurement of the lifetime as a function of the distance from the crucible walls which, in turn, can give some guidance on potential measures to be initiated for material quality improvement in the wafer level. Measurement c) can give orientation information about the ingot.

The modification of the furnace to fit the crucible can be any suitable modification known to those skilled in the art. The modification can include making the bolts, washers, or plates of a box that holds or surrounds the ceramic crucible thinner. The box holding the crucible can be made from graphite plates. The modification can also include counter-sinking or counter-boring into the graphite plate a nut that is part of the box, or otherwise reducing the profile of hardware that holds the box together. Joints between the graphite plates can be dadoed, mortised, or dovetailed. A bottom graphite plate that holds the crucible can be enlarged. A stainless steel cage for holding the movable elements can be made octagonal with diagonals added to the corners or the size of the diagonals can be enlarged. The insulation of a cage can be made thinner. The heating elements can be moved closer to a wall of the furnace or the heater cage. The graphite nuts holding heating elements together can be counter-sunk or counter-bored. Angled graphite washers can be used on the diagonal support plates to maintain a flat surface or custom shapes can be used to maintain flat section to fasten the graphite plates together. Corner extensions can be added to a corner piece of the heating element to move the heating elements out on all sides, including moving the heating elements out 3″ on all sides. A lip for sealing the bottom of the cage can be made smaller. The modification could also include lowering the stand that holds the crucible to allow for a taller crucible. The legs that support the crucible stand can be upgraded to support the extra weight by adding another leg, moving the legs further apart or threaded into a thicker cooling plate. Other insulating materials can be used for the insulating steel cage other than rigidized graphite felt so that the section can be made thinner. Two insulation materials can be used with one material used away from the hot face in a two layer design. The second insulating material would have better insulating properties so that a thinner cross section can be used for the cage.

All publications, patents, and patent applications are incorporated herein by reference. While in the foregoing specification this disclosed subject matter has been described in relation to certain preferred embodiments thereof, and many details have been set forth for purposes of illustration, it will be apparent to those skilled in the art that the disclosed subject matter is susceptible to additional embodiments and that certain of the details described herein can be varied considerably without departing from the basic principles of the disclosed subject matter.

What is claimed is:

1. A crucible comprising:
an interior for the production of an ingot; and,
an exterior shape approximately matching the interior shape of a furnace in which the ingot is produced.

2. The crucible of claim 1, wherein the ingot comprises a multiplicity of blocks.

3. The crucible of claim 2, wherein the blocks comprise a grid.

4. The crucible of claim 1, wherein the exterior shape matching the interior shape of the furnace allows the generation of a larger number of blocks than the number of blocks that can be generated from the furnace using a crucible with a square shape.

5. The crucible of claim 1, wherein the interior shape of the furnace comprises an approximately round shape.

6. The crucible of claim 1, wherein the perimeter of the crucible comprises approximately eight major sides, wherein the eight sides comprise two sets of approximately opposing first sides of approximately equal length, and two sets of approximately opposing second sides of approximately equal length, wherein the first sides alternate with the second sides.

7. The crucible of claim 7, wherein the first sides are longer than the second sides.

8. The crucible of claim 7, wherein the first sides are the same length as the second sides.

9. The crucible of claim 7, wherein the first sides comprise approximately flat sides.

10. The crucible of claim 7, wherein the second sides comprise approximately flat sides.

11. The crucible of claim 7, wherein the first sides comprise curved sides.

12. The crucible of claim 7, wherein the second sides comprise curved sides.

13. The crucible of claim 7, wherein the blocks comprise a grid, wherein compared to a grid in a square-shaped crucible, the percentage of side or center blocks relative to the percentage of corner blocks is increased.

14. The crucible of claim 1, comprising at least one of silica, quartz, graphite, or Si₃N₄.

15. A method for furnace capacity utilization, comprising,
use of the crucible of claim 1 to create an ingot.

16. The method of claim 15, further comprising the use of a cutting device to cut the ingot into the blocks.

17. The method of claim 16, wherein 32 156 mm×156 mm blocks are generated from a 25 block 156 mm×156 mm 450 kg ingot furnace

18. The method of claim 16, wherein 21 180 mm×180 mm blocks are generated from a 25 block 250 kg ingot furnace.

19. The method of claim 16, wherein the furnace comprises a furnace modified to fit the crucible.

20. The method of claim 16, wherein the ingots comprise silicon.

21. The method of claim 16, wherein analysis of the four partial corner blocks is used to determine quality of the ingot overall.

22. A crucible comprising:
an interior for the production of an ingot;
an exterior shape approximately matching the interior shape of a furnace in which the ingot is produced;
wherein the ingot comprises a multiplicity of blocks;
wherein the multiplicity of blocks comprise a grid;
wherein the exterior shape matching the interior shape of the furnace allows the generation of a larger number of blocks than the number of blocks that can be generated from the furnace using a crucible with a square shape;
wherein the interior shape of the furnace comprises an approximately round shape; and,
wherein the perimeter of the crucible comprises approximately eight major sides, wherein the eight sides comprise two sets of approximately opposing longer sides of approximately equal length, and two sets of approximately opposing shorter sides of approximately equal length, wherein the longer sides alternate with the shorter sides.
